(19) United States
(12) Patent Application Publication
(10) Pub. No.: US 2026/0246193 A1
(43) Pub. Date: Aug. 20, 2026

(54) WATERPROOF CONNECTOR AND WATERPROOF CAP THEREOF

(71) Applicants: KUNSHAN AMPHENOL ZHENGRI ELECTRONICS CO., LTD., Kunshan City (CN); AMPHENOL LTW TECHNOLOGY CO., LTD., New Taipei City (TW)

(72) Inventors: Yun-Chen LAI, New Taipei City (TW); Yu-Jun TSAI, New Taipei City (TW)

(21) Appl. No.: 19/088,776

(22) Filed: Mar. 24, 2025

(30) Foreign Application Priority Data
Feb. 19, 2025 (TW) 114106138

(51) Int. Cl. H01R 13/52

(52) U.S. Cl. CPC H01R 13/5213

(57) ABSTRACT

A waterproof connector and a waterproof cap thereof are disclosed. The waterproof connector includes: a connector body including a metal case having an inner circumferential surface and an outer circumferential surface with a recessed slot, the metal case has a buckling edge corresponding to the recessed slot; and the waterproof cap is sheathed with the metal case and includes an inner annular wall having a waterproof flange and an outer annular wall having a buckling flange and surrounding the inner annular wall, the waterproof flange and the buckling flange are disposed with a manner of facing each other, the buckling flange correspondingly penetrates into the recessed slot and is reversely buckled at the buckling edge, the waterproof flange abuts against the inner circumferential surface, and the waterproof flange and the buckling flange relatively abut and clamp the metal case.

### BACKGROUND OF THE DISCLOSURE

### Technical Field

The present disclosure relates to a connector, especially to a waterproof connector and a waterproof cap thereof.

### Description of Related Art

A connector used to be connected to a docking connector is disposed on a panel of an electronic device, thus external liquid or moisture may easily enter the connector. As such, a waterproof effect is required to be provided before the connecting process.

A related-art connector is disposed with a waterproof member for a purpose of having the waterproof effect. The waterproof member is disposed corresponding to an insertion port of the connector and has a pair of reversed hooks located at an outer side thereof. The waterproof member is fastened with the connector through the reversed hooks being reversely hooked on an outer wall of the connector. The waterproof member further has a waterproof pad capable of abutting against the connector. The waterproof pad is forced to be deformed due to the abutting process, thus the waterproof effect is provided.

However, the structure of the related-art waterproof member being fastened with the connector via the reversed hook has a problem of not having stable reliability. The reversed hook is easily dislocated or released from the outer side of the connector, and the reversed hook may not further push the connector towards the waterproof pad to generate a pressing effect (or a pushing force of the reversed hook being greatly reduced), thus the waterproof effect of the waterproof pad is affected. In other words, the waterproof member disposed in the related-art connector has undesirable waterproof effect, the external liquid or moisture may still enter the connector to damage components in the connector. As such, the aforesaid disadvantages shall be improved.

Accordingly, the applicant of the present disclosure has devoted himself for improving the mentioned shortages.

### SUMMARY OF THE INVENTION

The present disclosure provides a waterproof connector and a waterproof cap thereof, in which the waterproof cap is stably and reversely buckled with a connector body without the situations of dislocating or releasing, and the waterproof cap may tightly and firmly abut against the connector body for a better waterproof effect.

Accordingly, the present disclosure provides a waterproof cap, covering a connector body having a metal case, the metal case has an inner circumferential surface and an outer circumferential surface opposite to each other, the outer circumferential surface has a recessed slot, the metal case has a buckling edge corresponding to the recessed slot, the waterproof cap includes: an inner annular wall having a waterproof flange; and an outer annular wall, correspondingly surrounding the inner annular wall and having a buckling flange, the waterproof flange and the buckling flange are disposed with a manner of facing each other; wherein, the waterproof cap is sheathed with the metal case, the buckling flange correspondingly penetrates into the recessed slot and is reversely buckled at the buckling edge, the waterproof flange abuts against the inner circumferential surface, and the waterproof flange and the buckling flange relatively abut and clamp the metal case.

Accordingly, the present disclosure provides a waterproof connector, which includes: a connector body having a metal case, the metal case has an inner circumferential surface and an outer circumferential surface opposite to each other, the outer circumferential surface has a recessed slot, the metal case has a buckling edge corresponding to the recessed slot; and a waterproof cap, sheathed with the metal case and including an inner annular wall and an outer annular wall surrounding the inner annular wall, the inner annular wall has a waterproof flange, the outer annular wall has a buckling flange, the waterproof flange and the buckling flange are disposed with a manner of facing each other, the buckling flange correspondingly penetrates into the recessed slot and is reversely buckled at the buckling edge, the waterproof flange abuts against the inner circumferential surface, and the waterproof flange and the buckling flange relatively abut and clamp the metal case.

In comparison with related art, the present disclosure has advantageous features as follows. The buckling flange is ensured to be stably and reversely buckled at the buckling edge without the situations of dislocating or releasing, and the waterproof flange may tightly and firmly abut against the inner circumferential surface for a better waterproof effect. Moreover, external liquid and moisture are prevented from entering the connector body

### BRIEF DESCRIPTION OF THE DRAWINGS

FIG. 1 is a perspective exploded view showing the waterproof connector according to the present disclosure;

FIG. 2 is a perspective cross sectional view showing the waterproof cap according to the present disclosure;

FIG. 3 is a partially cross sectional view showing the waterproof connector before being assembled according to the present disclosure;

FIG. 4 is a perspective view showing the assembly of the waterproof connector according to the present disclosure; and

FIG. 5 is a partially cross sectional view showing the waterproof connector after being assembled according to the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

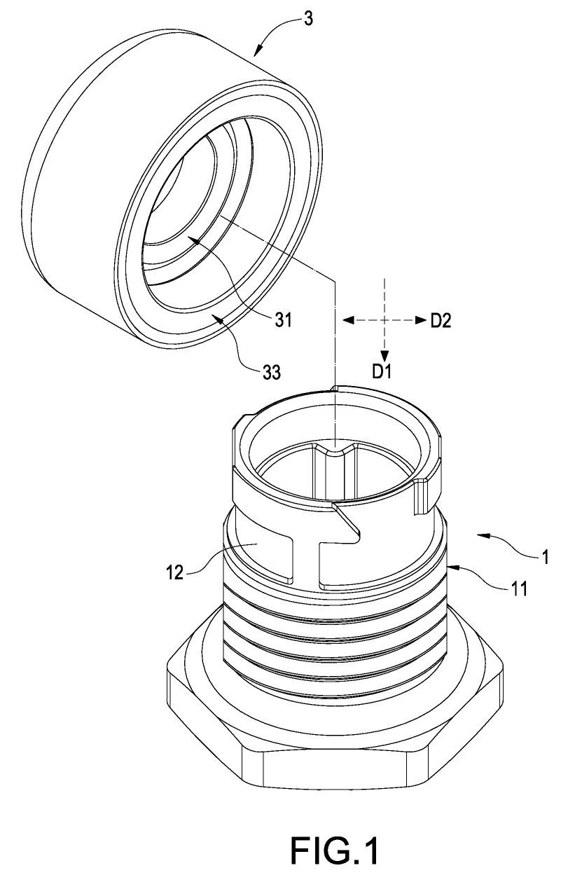

The present disclosure provides a waterproof connector and a waterproof cap thereof. The waterproof connector is fastened with an electronic device or a panel thereof (both not shown in figures) to make a docking connector (not shown in figures) be correspondingly inserted in the waterproof connector after the waterproof cap is removed. Please refer to FIG. 1, an insertion direction D1 is defined.

Please refer from FIG. 1 to FIG. 3, the waterproof connector of the present disclosure includes a connector body 1 and a waterproof cap 3. The connector body 1 has an insertion port 117 in which the docking connector is inserted. The waterproof cap 3 covers at a location corresponding to insertion port 117 to prevent external liquid or moisture from entering the connector body 1 via the insertion port 117.

The connector body 1 includes a metal case 11, a terminal assembly 14 and a fasten member 15. The metal case 11 is a hollow case member, thus the metal case 11 has an inner circumferential surface 111 and an outer circumferential surface 112 opposite to each other. The aforesaid insertion port 117 is formed at one end of the metal case 11. The metal case 11 defines the aforesaid insertion direction D1 and a radial direction D2, and the radial direction D2 is perpendicular to the insertion direction D1.

The outer circumferential surface 112 has a recessed slot 12 located close to the insertion port 117. The recessed slot 12 is a surrounding slot surrounding the outer circumferential surface 112 in a 360 degree manner, or the recessed slot 12 is a plurality concave slots surrounding the outer circumferential surface 112 and spacedly arranged, but here is not intended to be limiting. The outer circumferential surface 112 has an outer thread segment (not labeled) at a location corresponding to another end of the metal case 11 to make the fasten member 15 having an inner thread segment be threaded and combined. What shall be addressed is that a recessed direction of the recessed slot 12 is defined from the outer circumferential surface 112 towards the inner circumferential surface 111. As such, a slot port 123 facing the radial direction D2 is formed. A buckling edge 121 and a blocking edge 122 spacedly arranged are formed on the metal case 11 corresponding to the recessed slot 12 and along the insertion direction D1. The slot port 123 is located between the buckling edge 121 and the blocking edge 122.

The terminal assembly 14 is disposed in the metal case 11 to make a distal part of the terminal assembly 14 penetrate into the metal case 11, thus the terminal assembly 14 is mutually connected to the docking connector after the inserting process. Another distal part of the terminal assembly 14 protrudes out of the connector body 1 for a purpose of being soldered.

The waterproof cap 3 sheathes the metal case 11 at a location corresponding to the insertion port 117, thus the waterproof cap 3 is used to seal the insertion port 117. What shall be addressed is that the waterproof cap 3 defines a sheathing direction D1 which is as the same as the insertion direction D1, and defines the radial direction D2 perpendicular to the sheathing direction D1, thus the sheathing direction D1 and the insertion direction D1 are defined as being towards the same direction (thus sharing the same label), but the present disclosure is not limited to the insertion direction D1 or the sheathing direction D1 which are the same direction. In some embodiments, the insertion direction D1 is adopted for providing detailed illustrations.

The waterproof cap 3 is configured as a multi-piece assembled structure (not shown in figures) or an integrally formed structure as shown in figures, here is not intended to be limiting. In some embodiments, the integrally formed structure is adopted for providing detailed illustrations. The waterproof cap 3 includes an inner annular wall 31, an outer annular wall 33 and a cap body 35 which are internally formed. The inner annular wall 31 and the outer annular wall 33 are integrally extended from a surface of the cap body 35 along the insertion direction D1. The outer annular wall 33 and the inner annular wall 31 are mutually surrounded and spacedly arranged.

The inner annular wall 31 has a waterproof flange 311 substantially protruded along the radial direction D2. The outer annual wall 33 has a buckling flange 3322 substantially protruded along the radial direction D2. The waterproof flange 311 and the buckling flange 3322 are spacedly arranged and disposed with a manner of facing each other, thus a facing direction D3 is defined between the waterproof flange 311 and the buckling flange 3322. The waterproof flange 311 and the buckling flange 3322 are surrounding flanges surrounding in a 360 degree manner. What shall be addressed is that the waterproof cap 3 is made of a waterproof material and formed in one piece. The shape of the waterproof flange 311 is configured to be similar to a waterproof pad, thus the waterproof flange 311 is elastically deformed when being abutted to achieve a waterproof effect.

In some embodiments, a length of the outer annular wall 33 being integrally extended along the insertion direction D1 is greater than a length of the inner annular wall 31 being integrally extended along the insertion direction D1. In other words, the inner annular wall 31 and the outer annular wall 33 are in parallel with each other, but have different extended lengths, thus the aforesaid facing direction D3 inclines an angle relative to the radial direction D2, and inclines another angle relative to the insertion direction D1. As such, the waterproof flange 311 and the buckling flange 3322 are mutually inclined relative to the insertion direction D1 and spacedly arranged.

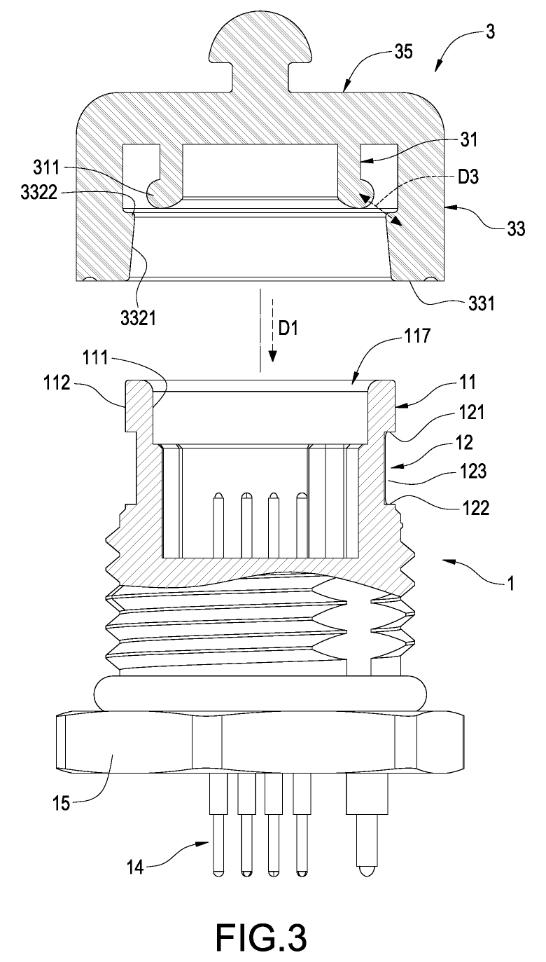

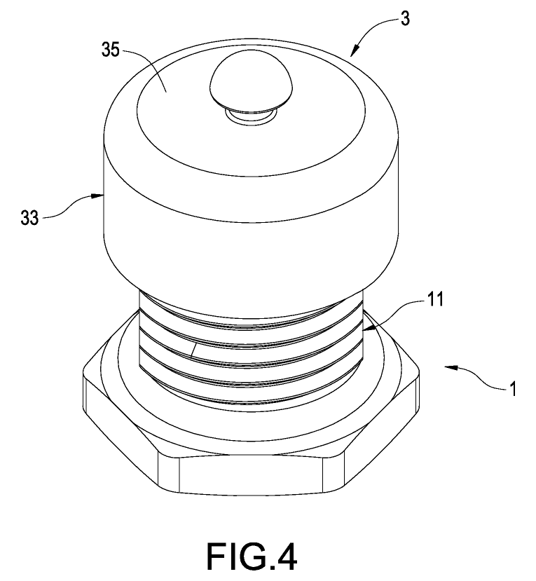

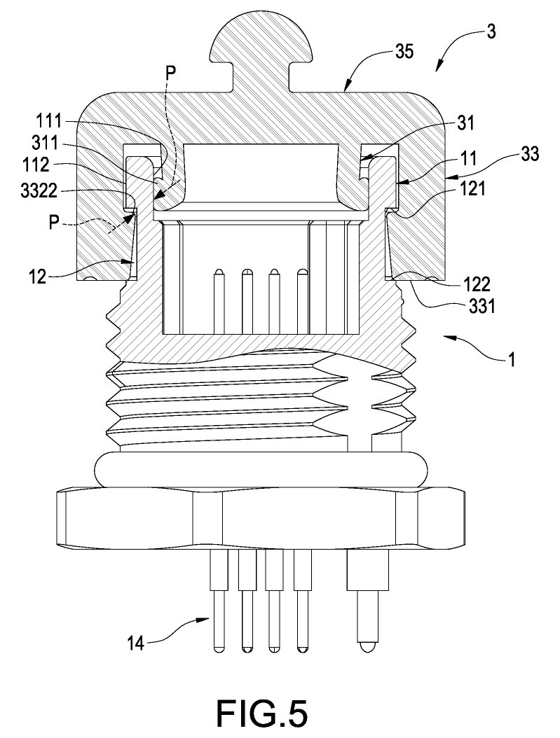

Please refer from FIG. 3 to FIG. 5, in assembly, when the waterproof cap 3 sheathes the metal case 11 along the insertion direction (the sheathing direction) D1 at the location corresponding to the insertion port 117, the buckling flange 3322 correspondingly penetrates into the recessed slot 12 and is reversely buckled at the buckling edge 121 of the metal case 11 along a direction opposite to the insertion direction D1, thus the waterproof cap 3 is removed from the connector body 1 along a direction opposite to the insertion direction D1. The waterproof flange 311 abuts against the inner circumferential surface 111 of the metal case 11, and is elastically deformed during the abutting process to achieve the waterproof effect as shown in FIG. 5, thus the waterproof flange 311 and the buckling flange 3322 relatively abut against the metal case 11 to mutually clamp the metal case 11. What shall be addressed are as follows. When the waterproof cap 3 sheathes the metal case 11, the outer annular wall 33 has a wall edge 331 formed at an extending distal end thereof, and the wall edge 331 is blocked by the blocking edge 122, thus the sheathing process of the waterproof cap 3 is finished, meanwhile relative positions where the waterproof flange 311 and the buckling flange 3322 clamp the metal case 11 are kept to be the same.

Please refer from FIG. 3 to FIG. 5, the waterproof flange 311 and the buckling flange 3322 both surrounding in the 360 degree manner respectively applies a clamping force P to clamp the metal case 11 (respectively clamping the inner circumferential surface 111 and the circumferential surface 112), thus the buckling flange 3322 is ensured to be stably and reversely buckled at the buckling edge 121 without the situations of dislocating or releasing, and the waterproof flange 311 may tightly and firmly abut against the inner circumferential surface 111 for a better waterproof effect, the external liquid and moisture are ensured to be prevented from entering the connector body 1 via the insertion port 117, and the external liquid and moisture are also prevented from permeating the connector body 1 from adjacently connected locations of the waterproof cap 3 and the metal case 11 via the insertion port 117. Accordingly, the waterproof effect is better than related-art technologies.

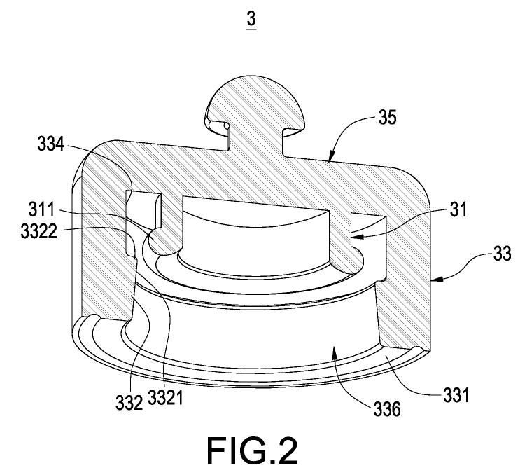

Please refer to FIG. 2, FIG. 3 and FIG. 5, a forming manner of the buckling flange 3322 is not intended to be limiting according to the present disclosure. In some embodiments, the forming manner of the buckling flange 3322 is a protruding piece 332 protruded from the outer annular wall 33.

Details are provided as follows. The protruding piece 332 surrounding in a 360 degree manner is formed on a surface of the outer annular wall 33 facing the inner annular wall 31 along the radial direction D2. The protruding piece 332 is corresponding to the recessed slot 12 and one corner thereof is formed with the buckling flange 3322, thus the protruding piece 332 is correspondingly mounted in the recessed slot 12 after the waterproof cap 3 is sheathed, and the buckling flange 3322 is reversely buckled at the buckling edge 121, thus the clamping forces P relatively clamping the metal case 11 are provided with a sufficient strength, and the buckling flange 3322 is ensured to be stably and reversely buckled at the buckling edge 121 without the situations of dislocating or releasing.

Please refer to FIG. 2, FIG. 3 and FIG. 5, for facilitating the waterproof cap 3 sheathing the metal case 11, the protruding piece 332 has a lateral surface 3321. The lateral surface 3321 faces the outer circumferential surface 112 and inclines a certain angle relative to the insertion direction D1, thus the outer annular wall 33 has a bell mouth 336 at a location corresponding to the lateral surface 3321. A caliber of the bell mouth 336 is gradually enlarged along the insertion direction D1 to facilitate the sheathing of the waterproof cap 3.

While this disclosure has been described by means of specific embodiments, numerous modifications and variations may be made thereto by those skilled in the art without departing from the scope and spirit of this disclosure set forth in the claims.

What is claimed is:

1. A waterproof cap, covering a connector body comprising a metal case, the metal case comprising an inner circumferential surface and an outer circumferential surface opposite to each other, the outer circumferential surface comprising a recessed slot, the metal case comprising a buckling edge corresponding to the recessed slot, and the waterproof cap comprising:
an inner annular wall, comprising a waterproof flange; and
an outer annular wall, configured to correspondingly surrounding the inner annular wall, and comprising a buckling flange, wherein the waterproof flange and the buckling flange are disposed with a manner of facing each other;
wherein, the waterproof cap sheathes the metal case, the buckling flange correspondingly penetrates into the recessed slot and is reversely buckled at the buckling edge, the waterproof flange abuts against the inner circumferential surface, and the waterproof flange and the buckling flange relatively abut against each other to clamp the metal case.

2. The waterproof cap according to claim 1, wherein the waterproof flange and the buckling flange are surrounding flanges in a surrounding manner.

3. The waterproof cap according to claim 1, wherein the outer annular wall comprises a wall edge for blocking.

4. The waterproof cap according to claim 1, wherein the waterproof cap comprises a sheathing direction and a radial direction defined perpendicular to the sheathing direction, a facing direction is defined between the waterproof flange and the buckling flange, and the facing direction inclines an angle relative to the radial direction.

5. The waterproof cap according to claim 4, wherein a length of the outer annular wall protruded along the sheathing direction is greater than a length of the inner annular wall protruded along the sheathing direction, and the inner annular wall and the outer annular wall are spacedly arranged along the radial direction.

6. The waterproof cap according to claim 1, wherein a protruding piece is disposed on a surface of the outer annular wall facing the inner annular wall, the protruding piece is used for embedding, and the buckling flange is disposed on the protruding piece.

7. The waterproof cap according to claim 6, wherein the waterproof cap comprises a sheathing direction and a radial direction defined perpendicular to the sheathing direction, the protruding piece is a surrounding piece and comprises a lateral surface, the lateral surface is inclined relative to the sheathing direction, the outer annular wall comprises a bell mouth defined corresponding to the lateral surface, and a caliber of the bell mouth is gradually enlarged along the sheathing direction.

8. The waterproof cap according to claim 1, wherein the waterproof flange is a waterproof pad made of a waterproof material.

9. The waterproof cap according to claim 1, wherein the waterproof flange is elastically deformable when being abutted.

10. A waterproof connector, comprising:
a connector body, comprising a metal case, the metal case comprising an inner circumferential surface and an outer circumferential surface opposite to each other, wherein the outer circumferential surface comprises a recessed slot, the metal case comprises a buckling edge corresponding to the recessed slot; and
a waterproof cap, adapted to sheathe the metal case, and comprising an inner annular wall and an outer annular wall surrounding the inner annular wall, wherein the inner annular wall comprises a waterproof flange, the outer annular wall comprises a buckling flange, the waterproof flange and the buckling flange are disposed with a manner of facing each other, the buckling flange correspondingly penetrates into the recessed slot and is reversely buckled at the buckling edge, the waterproof flange abuts against the inner circumferential surface, and the waterproof flange and the buckling flange relatively abut against each other to clamp the metal case.

11. The waterproof connector according to claim 10, wherein the metal case comprises an insertion direction and a radial direction defined perpendicular to the insertion direction, the recessed slot surrounds the outer circumferential surface and comprises a slot port, the slot port faces towards the radial direction, and the waterproof flange and the buckling flange are surrounding flanges in a surrounding manner.

12. The waterproof connector according to claim 10, wherein the metal case further comprises a blocking edge corresponding to the recessed slot, the buckling edge and the blocking edge are spacedly arranged, and the outer annular wall is blocked by the blocking edge.

13. The waterproof connector according to claim 10, wherein the metal case comprises an insertion direction and a radial direction defined perpendicular to the insertion direction, a facing direction is defined between the waterproof flange and the buckling flange, and the facing direction inclines an angle relative to the radial direction.

14. The waterproof connector according to claim 13, wherein a length of the outer annular wall protruded along the insertion direction is greater than a length of the inner annular wall protruded along the insertion direction, and the inner annular wall and the outer annular wall are spacedly arranged along the radial direction.

15. The waterproof connector according to claim 10, wherein a protruding piece is disposed on a surface of the outer annular wall facing the inner annular wall, and the protruding piece is embedded in the recessed slot, and the buckling flange is disposed on the protruding piece.

16. The waterproof connector according to claim 15, wherein the metal case comprises an insertion direction and a radial direction defined perpendicular to the insertion direction, the protruding piece is a surrounding piece and comprises a lateral surface facing the outer circumferential surface, the lateral surface is inclined relative to the insertion direction, the outer annular wall comprises a bell mouth defined corresponding to the lateral surface, and a caliber of the bell mouth is gradually enlarged along the insertion direction.

17. The waterproof connector according to claim 10, wherein the waterproof flange is a waterproof pad made of a waterproof material.

18. The waterproof connector according to claim 10, wherein the waterproof flange is elastically deformable when abutting against the inner circumferential surface.
